(19) United States
(12) Patent Application Publication
(10) Pub. No.: US 2012/0268251 A1
(43) Pub. Date: Oct. 25, 2012

(54) WIRELESS IDENTIFICATION TAG HAVING CIRCULARLY POLARIZED PLANAR ANTENNA

(75) Inventors: Sung-Lin CHEN, KAOHSIUNG CITY (TW); Chang-Tsun LIN, KAOHSIUNG CITY (TW); Shih-Kang KUO, KAOHSIUNG CITY (TW); Wei TANN, KAOHSIUNG CITY (TW)

(73) Assignee: CHINA STEEL CORPORATION, KAOHSIUNG (TW)

(21) Appl. No.: 13/288,981

(22) Filed: Nov. 4, 2011

(30) Foreign Application Priority Data
Apr. 21, 2011 (TW) 100113925

(51) Int. Cl. H04Q 5/22

(52) U.S. Cl. 340/10.1

(57) ABSTRACT

A wireless identification tag having circular polarization planar antenna is disclosed. The wireless identification tag includes a conductive substrate and a wireless identification device. The conductive substrate includes a first slot portion, a second slot portion, and a third slot portion. The first slot portion, the second slot portion, and the third slot portion pass through the conductive substrate. The first slot portion and the second slot portion stretch in a first direction and a second direction, respectively. The angle between the first direction and the second direction is between 45 degrees and 135 degrees. The third slot portion is connected between the first slot portion and the second slot portion. The wireless identification device is disposed in the first slot portion or the second slot portion. The wireless identification device is used to transmit or receive an electric wave.

### RELATED APPLICATIONS

This application claims priority to Taiwan Application Serial Number 100113925, filed Apr. 21, 2011, which is herein incorporated by reference.

### BACKGROUND

1. Field of Invention

The present invention relates to a wireless identification tag having a circularly polarized planar antenna. More particularly, the present invention relates to a wireless identification tag applicable to variable coupling signal sources.

2. Description of Related Art

Because radio frequency identification (RFID) technology has the features of repeatable reading/writing, storing more information, accessing without needing to aim, simultaneously reading variable identification signals, fast reading, and easily implementing automatic operation, etc., the RFID technology is widely used in logistics and other industries, wherein the RFID technology applied on an ultra-high frequency band (860-960 MHz) is the most popular.

In the RFID technology applying ultra-high frequency, a RFID tag is usually designed to have a structure of linear polarization to obtain the characteristic of isotropic radiation. However, the antenna having linear polarization structure still has problems about the limitations of the match for the polarization direction of the antenna, so that there is a great inconvenience in the practice of the antenna.

For solving the problems about the polarization direction of the antenna, the industries provide variable methods to improve the antenna.

For example, in a case of Taiwan Patent Number 1236318, two micro strip lines are disposed in orthogonal, thereby obtaining a relation that the included angle between two radiation bodies is equal to 90 degrees in space, and a transmission line of which the length is equal to ¼ wavelength is used to achieve the effect of phase difference equal to 90 degrees, so that a design of circularly polarized antenna is implemented. However, the circularly polarized antenna itself needs a grounding structure to enable the radiation pattern thereof simply shows the characteristic of single direction radiation, and when the antenna structure is designed to operate at UHF, the size of a finished product of the antenna is not easy to be decreased.

According to the above analysis, a new wireless identification tag applicable to variable coupling signal sources and having circular radiation pattern is provided.

### SUMMARY

An aspect of the present invention is to provide a wireless identification tag having a circular polarization planar antenna, wherein the wireless identification tag is applicable to variable coupling signal sources and able to provide a radiation pattern of circular polarization.

According to an embodiment of the present invention, the wireless identification tag comprises an electrically conductive substrate and a wireless identification device. The electrically conductive substrate comprises a first slot portion, a second slot portion, and a third slot portion. The first slot portion stretches along a first direction in parallel with the electrically conductive substrate, wherein the first slot portion substantially passes through the electrically conductive substrate and has a first width. The second slot portion stretches along a second direction in parallel with the electrically conductive substrate, wherein the second slot portion substantially passes through the electrically conductive substrate and has a second width, and an angle between the first direction and the second direction is between 45 degrees and 135 degrees. The third slot portion is connected between the first slot portion and the second slot portion, wherein the third slot portion substantially passes through the electrically conductive substrate and has a third width. The wireless identification device is used to receive or transmit an electromagnetic wave signal, wherein the wireless identification device is disposed in the first slot portion or the second slot portion.

It is to be understood that the wireless identification tag provided by the embodiment of the present invention has two larger slot portions designed to be applicable to variable coupling sources and finished products of tag, and in the design of the wireless identification tag, single slot radiation body is designed fir variable coupling source, accordingly. Further, the wireless identification tag provided by the embodiment of the present invention can provide a radiation pattern of circular polarization to improve a problem about signal receiving.

### BRIEF DESCRIPTION OF THE DRAWINGS

The invention can be more fully understood by reading the following detailed description of the embodiment, with reference made to the accompanying drawings as follows, and single slot radiation body can be designed

FIG. 1 is a diagram showing a structure of a wireless identification tag in accordance with an embodiment of the present invention;

FIG. 2 is a diagram showing the relation between axial ratios and operation frequencies in accordance with an embodiment of the present invention;

FIG. 3 is a diagram showing an equivalent circuit of the antenna of the wireless identification tag in accordance with an embodiment of the present invention;

FIG. 4a is a diagram showing a structure of a wireless identification tag in accordance with an embodiment of the present invention;

FIG. 4b is a diagram showing a radiation pattern of circular polarization in accordance with an embodiment of the present invention;

FIG. 5a and FIG. 5b are diagrams showing structures of electrically conductive substrates in accordance with an embodiment of the present invention; and

FIG. 6 is a diagram showing a structure of a wireless identification tag in accordance with an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

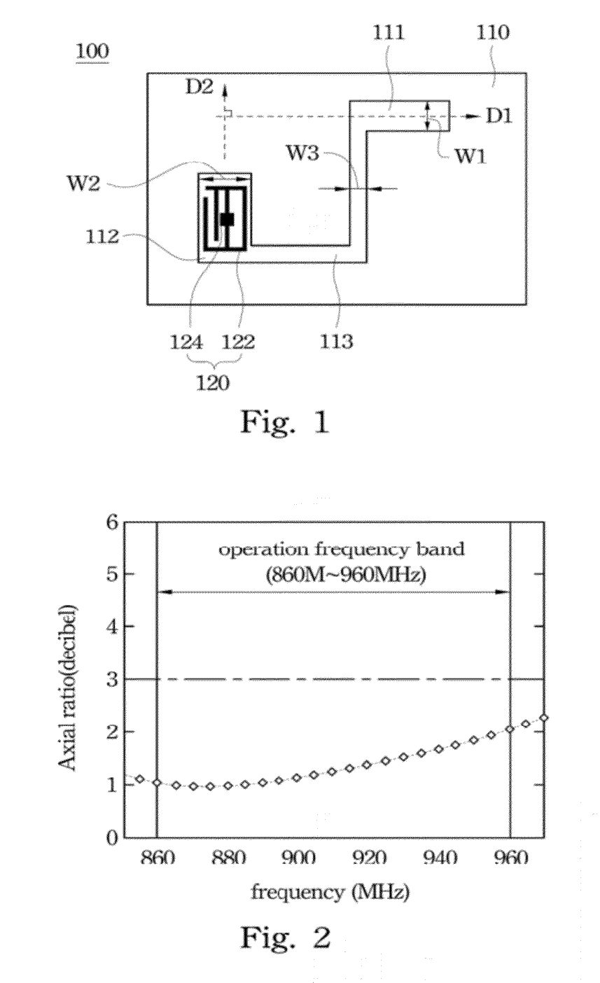

Referring to FIG. 1, FIG. 1 is a diagram showing a structure of a wireless identification tag 100. The wireless identification tag 100 includes an electrically conductive substrate 110 and a wireless identification device 120. The electrically conductive substrate 110 includes a first slot portion 111, a second slot portion 112, and a third slot portion 113. The first slot portion 111 and the second slot portion 112 are used for receiving the wireless identification device 120. A user can select one of the first slot portion 111 and the second slot portion for receiving the wireless identification device 120 in accordance with the characteristics of the wireless identification device 120. The electrically conductive substrate is made of metal materials having high electrical conductivity such as copper, iron, etc.

The wireless identification device 120 includes an antenna 122 and a wireless radio frequency (RF) chip 124. In this embodiment, the antenna 122 is a dipole antenna. More particularly, the antenna 122 is an indirect coupling feed-in antenna, and the wireless radio frequency chip 124 is a RFID chip (for example having impedance equal to 16-130 j ohm) for transmitting or receiving radio frequency signals.

The first slot portion 111 passes through the electrically conductive substrate 110 and stretches along a first direction D1 in parallel with the electrically conductive substrate 110. The second slot portion 112 also passes through the electrically conductive substrate 110 and stretches along a second direction D2 in parallel with the electrically conductive substrate 110. It is can be understood from FIG. 1 that there is an angle between the stretching direction D1 of the first slot portion 111 and the stretching direction D2 of the second slot portion 112. In this embodiment, the stretching direction D1 is perpendicular to the stretching direction D2, and it means that the angle is 90 degrees. However, the embodiments of the present invention are not limited thereto. In other embodiments of the present invention, the angle between the stretching direction D1 and the stretching direction D2 is between 45 degrees and 135 degrees. In addition, in this embodiment, when the angle is between 90±10 degrees, the stretching direction D1 and the stretching direction D2 are considered as being perpendicular to each other. The third slot portion 113 passes through the electrically conductive substrate 110 and lies between the first slot portion 111 and the second slot portion 112, thereby connecting the first slot portion 111 with the second slot portion 112.

The first slot portion 111 has a first width W1, and the second slot portion 112 has a second width W2, and the third slot portion 113 has a third width W3. In this embodiment, the third with W3 is smaller than the first path W1 and the second width W2, and the length of the third slot portion 113 is equal to one fourth of the wavelength of an electromagnetic wave signal transmitted by the wireless radio frequency chip 124. However, the embodiments of the present invention are not limited there to. In other embodiments of the present invention, the width and length of the third slot portion 113 can varied in accordance with actual demands.

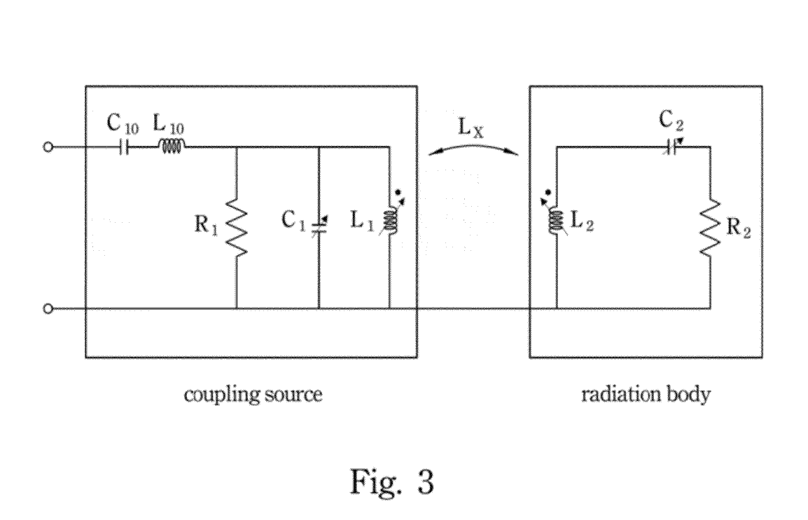

In this embodiment, the wireless identification tag 100 has a radiation characteristic of approximately circular polarization as shown in FIG. 2, and the radiation characteristic is produced by the shape of the slots, and the design and arrangement of slot locations described above. It can be understood from the analysis of axial ratios shown in FIG. 2 that the wireless identification tag 100 of this embodiment has a good circular polarization characteristic and a good operable bandwidth of circular polarization. In addition, the wireless identification tag 100 of this embodiment can radiate from a backside and a front-side, so that the use of the tag 100 designed in this embodiment is more convenient than that of a conventional tag having a grounding structure and a characteristic of single radiation direction.

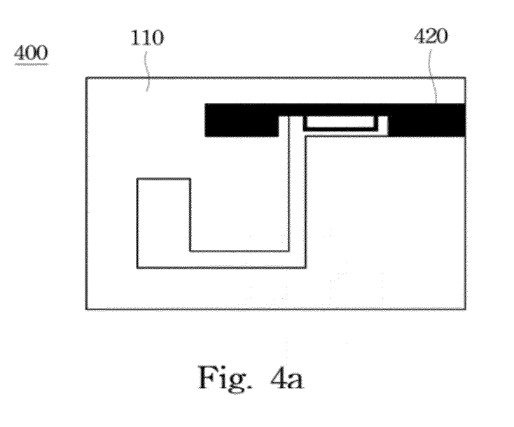

In addition, this embodiment has a high degree of freedom about adjustment of the impedance of the tag 100. Referring to FIG. 3, FIG. 3 is a diagram showing an equivalent circuit of the antenna of the wireless identification tag 100, wherein an equivalent circuit of the dipole antenna is presented as a coupling source portion shown in the left side of FIG. 3, and the characteristic of a radiation body is equivalent to a radiation body portion shown in the right side of FIG. 3, and the coupling effect between the coupling source portion and the radiation body portion is equivalent to a mutual inductance Lₓ shown in FIG. 3 through an operation principle of a transformer. The radiation body portion is constructed by an equivalent resistor R₂, an equivalent capacitor C₂, and an equivalent inductor L₂. The coupling source portion is constructed by an equivalent capacitor C₁₀, an equivalent inductor L₁₀, an equivalent resistor R₁, an equivalent capacitor C₁, and an equivalent inductor L₁.

Regarding a resonant frequency of the coupling source, the resonant frequency fₛ can be represented by fₛ=1/(2π\sqrt{L₁×C₁}), so that the value of the resonant frequency fₛ of the coupling source can be controlled by the adjustments of a loop size (i.e., the value of L₁) and a stretching micro strip line length (i.e., the value of C₁) of the dipole antenna. Regarding the resonant frequency fᵣ of the radiation body, the resonant frequency fᵣ can be determined in accordance with the size of the radiation body and the type of the slots. Through the arrangement and the control of the relative position between the two resonant frequencies fₛ and fᵣ, a tag antenna featured in wide bandwidth can be developed, and the degree of freedom about the design of the antenna impedance is increased as well, so that a conjugate match between the impedance of the RFID chip (i.e., 16-130 j ohm in this embodiment) and the impedance of the dipole antenna is easily implemented.

In addition, the first slot portion 111 and the second slot portion 112 have different sizes. The sizes of the first slot portion 111 and the second slot portion 112 are determined in accordance with the wireless identification device 120 applied by the user. In this embodiment, the first slot portion 112 is designed for receiving a customized wireless identification device, and the first slot portion 111 is designed for receiving a finished product of a RFID tag available on market.

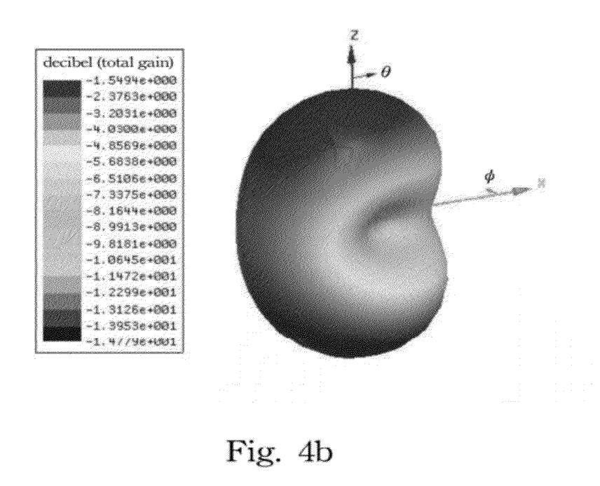

Referring to FIG. 4a, FIG. 4a is a diagram showing a structure of a wireless identification tag 400 in accordance with an embodiment of the present invention. The wireless identification tag 400 is similar to the wireless identification tag 100, but the difference is in that the wireless identification tag 400 uses a finished product of a RFID tag available on market. In order to fix the RFID tag finished product in the first slot portion 111, this embodiment uses a fixing element such as an adhesive tape to fix the RFID tag finished product in the first slot portion 111, so that the wireless identification tag 400 can provide a radiation pattern of circular polarization (as shown in FIG. 4b).

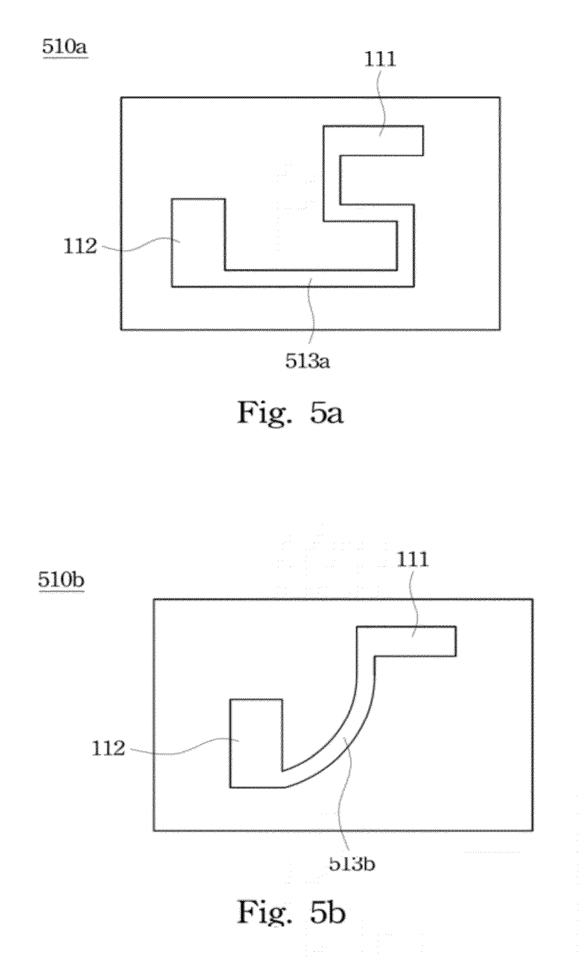

Referring to FIG. 5a and FIG. 5b, FIG. 5a and FIG. 5b are diagrams showing structures of electrically conductive substrates 510a and 510b. The electrically conductive substrates 510a and 510b are similar to the electrically conductive substrate 110, but the difference is in that the shapes of the third slot portion 513a and 513b of the electrically conductive substrates 510a and 510b are different from that of the third slot portion 113 of the electrically conductive substrate 110. As shown in FIG. 5a and FIG. 5b, the third slot portion 513a of the electrically conductive substrate 510a has a plurality of corners, and the third slot portion 513b of the electrically conductive substrate 510b has a curved structure. Although the shapes of the slot portions 513a and 513b are different from that of the third slot portion 113 of the electrically conductive substrate 110, wireless RFID tags utilizing the electrically conductive substrates 510a and 510b can still have a good circular polarization characteristic when the length thereof meet the requirement of one-fourth wavelength.

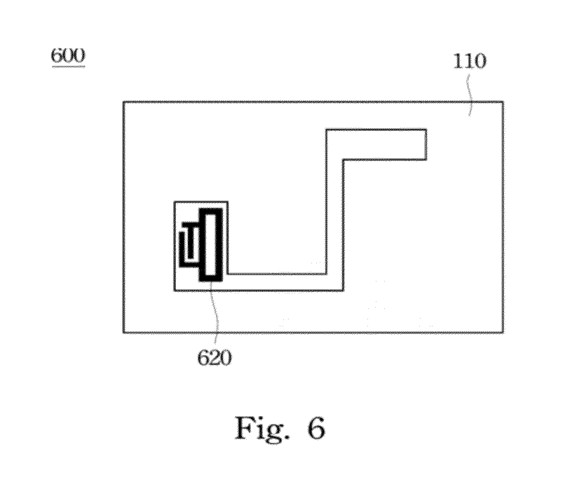

Referring to FIG. 6, FIG. 6 is a diagram showing a structure of a wireless identification tag 600 in accordance with an embodiment of the present invention. The wireless identification tag 600 is similar to the wireless identification tag 100, but the difference is in that a wireless identification device 620 of the wireless identification tag 600 utilizes a RFID chip having different impedance. In this embodiment, the impedance of the RFID chip of the wireless identification device 620 is equal to 27-180 j ohm. It can be understood from the equivalent circuit diagram and the relative descriptions that although the impedance of the RFID chip of the wireless identification device is varied, the wireless identification tag 600 can still provide a radiation pattern of circular polarization through a proper slot design.

In accordance with the above descriptions, the wireless identification tags of the embodiments of the present invention can provide the radiation pattern of circular polarization, and the slot portions of the wireless identification tags can be designed for RFID chips sold by variable vendors or having different impedance, so that the slot radiation body can be applicable to variable in RFID tag chips or finished products of RFID tag. Further, the wireless identification tag can use a dipole antenna with a small size to be the coupling source, so that the degree of freedom about adjustment of the impedance of the antenna is increased and it is easy to design an antenna conjugate matching variable finished products of RFID tag in market. Furthermore, the wireless identification tags of the embodiments of the present invention can be produced in variable ways. For example, the radiation body and the coupling source thereof can be a monocoque structure. For another example, the radiation body and the coupling source can be fabricated in separate at first, and then combined.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A wireless identification tag having a circularly polarized planar antenna, the wireless identification tag comprising:
an electrically conductive substrate, comprising:
a first slot portion stretching along a first direction in parallel with the electrically conductive substrate, wherein the first slot portion substantially passes through the electrically conductive substrate and has a first width;
a second slot portion stretching along a second direction in parallel with the conductive substrate, wherein the second slot portion substantially passes through the electrically conductive substrate and has a second width, and an angle between the first direction and the second direction is substantially between 45 degrees and 135 degrees; and
a third slot portion connected between the first slot portion and the second slot portion, wherein the third slot portion substantially passes through the electrically conductive substrate and has a third width; and
a wireless identification device used to receive or transmit an electromagnetic wave signal, wherein the wireless identification device is disposed in the first slot portion or the second slot portion.

2. The wireless identification tag of claim 1, wherein the length of the third slot portion is one-forth of the wavelength of the electromagnetic wave signal.

3. The wireless identification tag of claim 1, wherein the angle is between 80 degrees and 100 degrees.

4. The wireless identification tag of claim 1, wherein the angle is 90 degrees.

5. The wireless identification tag of claim 1, wherein the wireless identification device comprises:
a wireless identification chip; and
an antenna electrically connected to the wireless identification chip.

6. The wireless identification tag of claim 5, wherein the antenna is a dipole antenna.

7. The wireless identification tag of claim 5, wherein the antenna is an indirect coupling feed-in antenna.

8. The wireless identification tag of claim 1, wherein the conductive substrate is a metal substrate.

9. The wireless identification tag of claim 8, wherein the conductive substrate is made of copper or iron.

10. The wireless identification tag of claim 1, further comprising a fixing element used to fix the wireless identification device in the first slot portion or the second slot portion, wherein the fixing element is an adhesive tape.
